(19) United States
(12) Patent Application Publication
(10) Pub. No.: US 2010/0143646 A1
(43) Pub. Date: Jun. 10, 2010

(54) PAPER PRODUCTS HAVING SOLID SUPPORT MATERIALS

(76) Inventor: Kathryn Christian Kien, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/328,183

(22) Filed: Dec. 4, 2008

(51) Int. Cl. B32B 29/06; B32B 29/04; B32B 29/02

(52) U.S. Cl. 428/131; 428/338; 428/332; 428/218; 428/212

(57) ABSTRACT

A paper product having one or more plies of fibrous structure; a plurality of solid support materials embedded into or affixed to the fibrous structure; wherein the solid support materials have a length of from about 0.5 mm to 60 mm, a width from about 0.5 mm to 60 mm, and a z-direction thickness from about 0.05 mm to about 5 mm.

### FIELD OF THE INVENTION

The present invention relates to paper products (i.e., paper towels, napkins, facial tissue, and bath tissue) comprising a plurality of visually discernable solid support materials embedded into, or otherwise disposed, thereon.

### BACKGROUND OF THE INVENTION

Fibrous structure products are a staple of everyday life. Fibrous structure products may be used as consumer products for paper towels, toilet tissue, facial tissue, napkins, and the like. The large demand for such paper products has created a demand for improved versions of the products and the methods of their manufacture.

Paper product manufacturers offer a variety of paper products having different features and benefits. For example, the use of lotions in facial tissue attracts consumers who appreciate softness and smoothness in their paper products. Various embossing or converting techniques are often applied to paper towels to provide a quilted or otherwise thick appearance to the sheet. Providing these benefits will often drive consumer demand for these products. Sometimes these benefits, however, are not discernable to the consumer from simple visual inspection of the product. As a result, producers of such products often rely on advertising campaigns, packaging methods, sampling means, or other methods in order to direct the consumers to the benefits.

In addition consumers desire paper products that maintain their performance, such as thickness, during the use of the product, especially when wet.

Thus, there exists a need for paper products wherein the product's benefits, such as thickness during use, are more clearly discernable and are visually relayed to the consumer, through the product's appearance.

### SUMMARY OF THE INVENTION

In one embodiment, the present invention is directed to a paper product comprising: one or more plies of fibrous structure; a plurality of solid support materials embedded into or affixed to the fibrous structure; wherein the solid support materials have a length of from about 0.5 mm to about 60 mm, a width from about 0.5 mm to about 60 mm, and a z-direction thickness from about 0.05 mm to about 5 mm. Furthermore, in an embodiment the paper product comprises a Thickness Ratio of from about 1 to about 2, and/or from about 1 to about 1.5. In an embodiment the paper product is in roll form.

### BRIEF DESCRIPTION OF THE DRAWINGS

While the specification concludes with claims that particularly point out and distinctly claim the present invention, it is believed that the present invention will be understood better from the following description of embodiments, taken in conjunction with the accompanying drawings, in which like reference numerals identify identical elements.

FIG. 1A is a perspective view of an exemplary roll paper product of the present invention.

FIG. 1B is a top view of an exemplary single ply sheet of roll paper product of the present invention.

FIG. 1C is a cross-sectional view the exemplary sheet of FIG. 1B taken along line 1C-1C.

FIG. 2A is a top view of an exemplary single ply sheet of a paper product of the present invention.

FIG. 2B is a cross-sectional view the exemplary sheet of FIG. 2A taken along line 2B-2B.

FIG. 3A is a top view of an exemplary multi ply sheet of a paper product of the present invention.

FIG. 3B is a cross-sectional view the exemplary sheet of FIG. 3A taken along line 3B-3B.

FIG. 4 is an alternative embodiment of a cross-sectional view a 2 ply sheet of the present invention.

FIG. 5 is an alternative embodiment of a cross-sectional view a 2 ply sheet of the present invention.

FIG. 6 is an alternative embodiment of a cross-sectional view a 2 ply sheet of the present invention.

FIG. 7 is a perspective view of an exemplary roll paper product of the present invention.

### DETAILED DESCRIPTION OF THE INVENTION

### Definitions

“Paper product,” as used herein, refers to any formed, fibrous structure products, traditionally, but not necessarily, comprising cellulose fibers. In one embodiment, the paper products of the present invention include paper towel products. Non-limiting examples of paper products includes paper towels, facial tissue, bath tissue, napkins, and combinations thereof.

“Roll paper product,” as used herein, refers to a paper product which may be provided in a roll form, for example, a paper towel product which may be wound around a core. In another embodiment, a paper towel product may simply be wound about an axis without a core.

“Ply” or “Plies”, as used herein, means an individual fibrous structure or sheet of fibrous structure, optionally to be disposed in a substantially contiguous, face-to-face l s relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the layers may or may not be homogenous within a layer. The actual makeup of a fibrous structure product ply is generally determined by the desired benefits of the final tissue-towel paper product, as would be known to one of skill in the art. The fibrous structure may comprise one or more plies of non-woven materials in addition to the wet-laid and/or air-laid plies.

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

“Z-direction,” as used herein, means the direction normal to a plane formed by machine direction and cross machine directions.

“Basis Weight”, as used herein, is the weight per unit area of a sample of fibrous structure reported in lbs/3000 ft² or g/m².

“Solid support material”, as used herein, means an organic or inorganic material or particles, that may be affixed or deposited onto, or embedded into one or more plies of fibrous structure. In an embodiment the solid support materials have a length of from about 0.5 mm to 60 mm and/or about 1 mm to about 10 mm and/or about 1 mm to about 4 mm; a width from about 0.5 mm to 60 mm and/or about 1 mm to about 10 mm and/or about 1 mm to about 4 mm; and a z-direction thickness from about 0.05 mm to about 5 mm and/or about 0.1 mm to about 2 mm.

In some embodiments, solid support material does not include mis-processed furnish. One of skill in the art will appreciate that low-cost paper products sometimes include “chunks” or other imperfections and/or non-uniformities in the finished product. Such imperfections are sometimes referred to by those of skill in the art as “floes” or “flocculations”. A large amount of time and resources is directed to removal or minimization of such non-uniformities in the final paper product. Exemplary means and/or methods are described in U.S. Pat. Nos. 4,145,249, 3,960,654, 4,049,491. This is often due to mis-refining and/or mis-processing of the paper fibers.

In one embodiment, solid support material includes, but is not limited to: plant material, flower petals, leaves, fabric, sponge, cork, plastic, newspaper, soap, inorganic materials, shavings, the like, and combinations thereof. In one embodiment, a solid support material is visually discernable as distinct from the ordinary paper fibers in the finished product. Nonlimiting examples of differences in properties of the fibrous structure and the solid support material, which may lead to the solid support material being visually discernable as distinct from the ordinary paper fibers, are: color, consistency, weight, density, shape, basis weight, light transmission, light absorption, and combinations thereof.

In some embodiments, inks, dyes, adhesives, binder, and/or glues are not solid support materials. In other embodiments, multifilament fibers are not solid support materials. In some embodiments the solid support material is a non-paper and/or non-cellulose material. In an embodiment, the solid support material may be provided as discrete forms. In some embodiments, solid support material may occupy from about 0.5% to about 50% and/or from about 1% to about 35%, and/or from about 1% to about 25%, by weight of the fibrous structure product.

The length and width of the solid support material is determined by creating and fitting the smallest 2-D rectangle or square (the 2-D rectangle or square being in the same plane as the fibrous structure) to be able to completely enclose and fit around a solid support material so that all parts of the solid support material are within the 2-D rectangle or square. Designate one side of the 2-D rectangle or square as the length. The side perpendicular to the designated length is the width. The z-direction thickness is measured according to the method disclosed herein.

“Embedded”, as used herein, means that a solid support material is integral to, or set into, the fibrous structure. Solid support material may be embedded into the substrate at any point during, or after, the papermaking and/or converting process.

“Affixed to”, as used herein, means that a solid support material is attached, adhered, or otherwise chemically or mechanically affixed, to a substrate such as the fibrous structure. Solid support material may be affixed to the substrate at any point during, or after, the papermaking and/or converting process.

“Fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process. The present invention contemplates the use of a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps; mechanical pulps including groundwood, thermomechanical pulp; chemithermomechanical pulp; chemically modified pulps, and the like. In an embodiment chemical pulps, may be used to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from non-wood pulp such as cotton linters, bagesse, and the like, can be used. Additionally, fibers derived from recycled paper, which may contain any or all of the pulp categories listed above, as well as other non-fibrous materials such as fillers and adhesives used to manufacture the paper product. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, lyocel, polyester, polyethylene, and polypropylene fibers can be used within the scope of the present invention. Further, such fibers may be latex bonded. Other materials are also intended to be within the scope of the present invention as long as they do not interfere or counter act any advantage presented by the instant invention.

In addition synthetic fibers useful in the present invention include any material, such as, but not limited to, those selected from the group consisting of polyesters, polypropylenes, polyethylenes, polyethers, polyamides, polyhydroxyalkanoates, polysaccharides, and combinations thereof. The synthetic fiber may comprise a polymer. The polymer may be any material, such as, but not limited to, those materials selected from the group consisting of polyesters, polyamides, polyhydroxyalkanoates, polysaccharides and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or mixture makes up entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples of suitable bicomponent fibers are fibers made of copolymers of polyester (polyethylene terephthalate)/polyester (polyethylene terephthalate) (otherwise known as “CoPET/PET” fibers), which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to lo make them more hydrophilic, more wettable, etc.

Multicomponent and/or synthetic fibers are further described in U.S. Pat. Nos. 6,746,766 and 6,890,872; U.S. Pat. Pub. Nos. 2003/0077444A1, 2003/0168912A1, 2003/0092343A1, 2002/0168518A1, 2005/0079785A1, 2005/0026529A1, 2004/0154768A1, 2004/0154767, 2004/0154769A1, 2004/0157524A1, and 2005/0201965A1.

“Fibrous structure product”, as used herein, refers to products comprising paper tissue or paper towel technology in general, including, but not limited to, conventional felt-pressed or conventional wet-pressed fibrous structure product, pattern densified fibrous structure product, starch substrates, and high bulk, uncompacted fibrous structure product. Non-limiting examples of tissue-towel paper products include disposable or reusable, toweling, facial tissue, bath tissue, table napkins, placemats, wipes, and the like.

### Paper Product

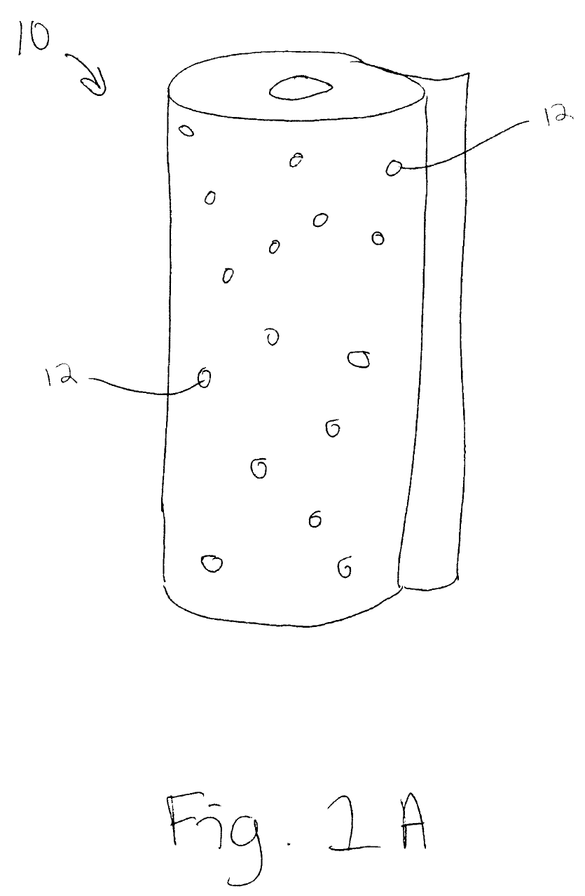

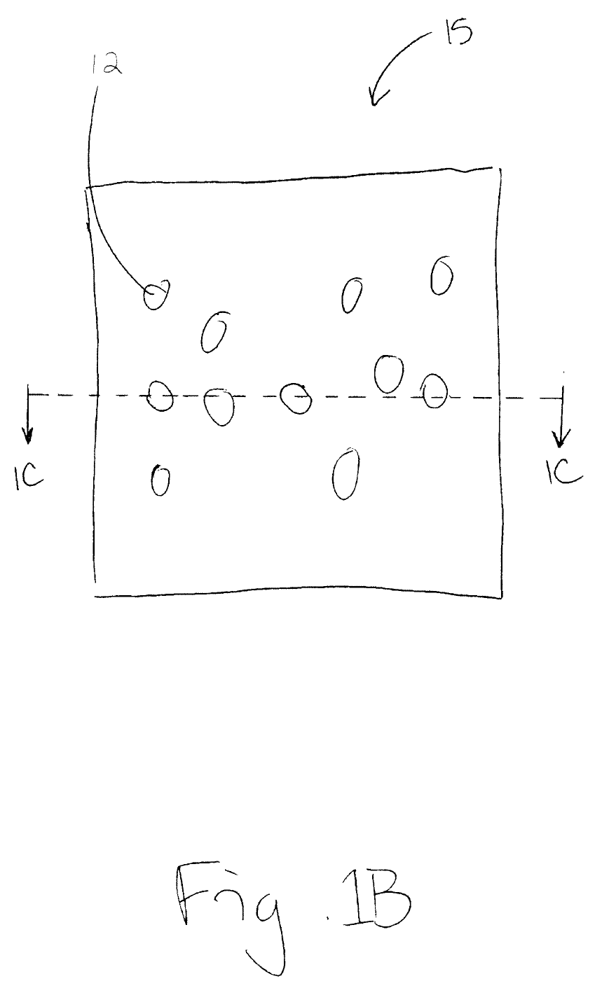

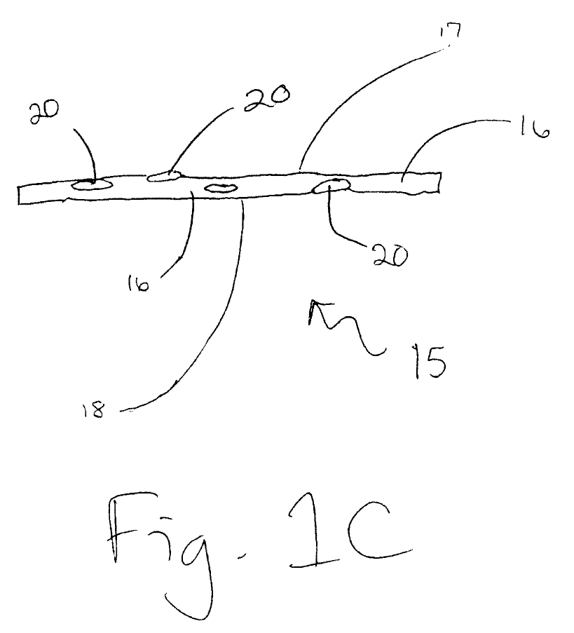

FIG. 1A shows a perspective view of an exemplary embodiment of a roll paper product 10 of the present invention. In one embodiment, the roll paper product (or product) 10 comprises a plurality of solid support materials 12 embedded into the product 10. FIG. 1B shows a top view of an embodiment of a single ply sheet 15 of the roll paper product 10 (FIG. 1A) comprising a plurality of solid support materials 12 embedded into the single ply sheet 15. FIG. 1C is a cross-sectional view of the single ply sheet 15 of FIG. 1B taken along the line 1C-1C. The cross-sectional view shows a plurality of solid support materials 12 are actually integrated into the fibrous structure 16 of the single ply sheet 15.

In some embodiments, solid support materials 12 may be visible to consumers because certain solid support materials 12 may be exposed through the surface of the ply of fibrous structure that faces outward toward the consumer. In additional embodiments, certain solid support materials 12 may be visible to consumers “through” the single ply sheet 15 despite being embedded into the sheet and not actually being in contact with the top portion 17 of the sheet and/or with the bottom portion 18 of the sheet. This effect may be brought about by providing solid support materials 12 which have different physical properties compared to the fibrous structure 16 surrounding the solid support materials 12. In one embodiment, the surrounding fibrous structure 16 is substantially uniform in one or more of the following: color, consistency, weight, basis weight, density, light transmission, light absorption, material, and the like. A solid support material 12 may differ from the fibrous structure 16 in the following nonlimiting ways: color, consistency, weight, basis weight, density, shape, light transmission, light absorption, refraction, luminosity, the like, and combinations thereof. In other embodiments, embedded solid support materials 12 may not be visible through the fibrous structure 16, but may be visible if at least part of the solid support material 12 is exposed through either the top portion 17 or the bottom portion 18 of the sheet 15.

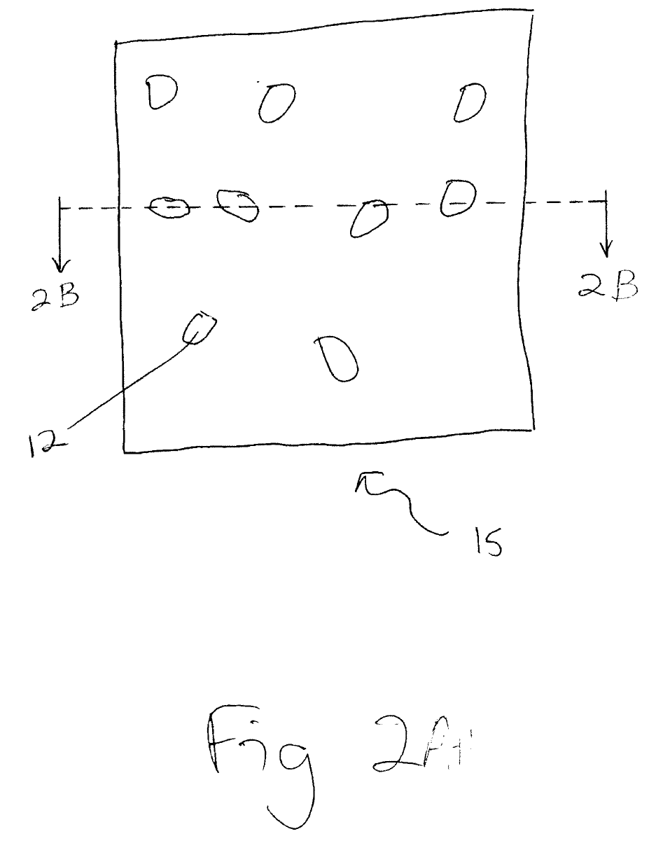

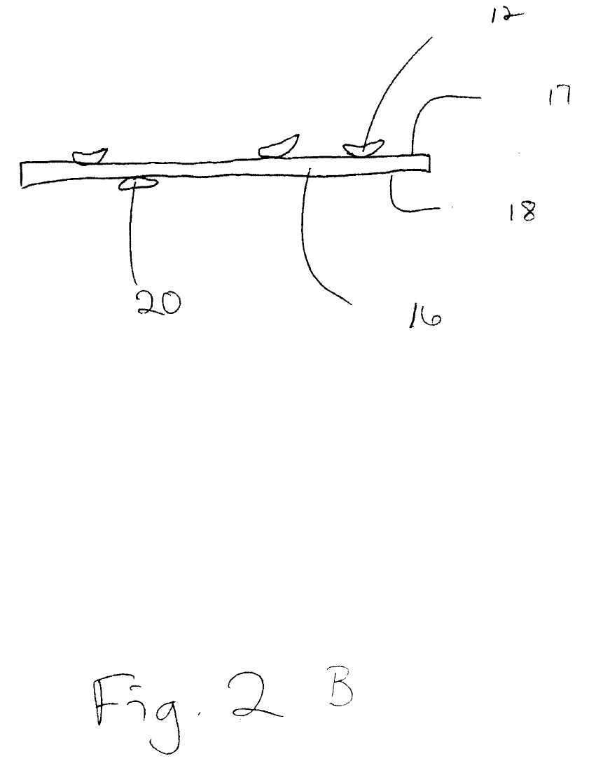

FIG. 2A shows a top view of an embodiment of a single ply sheet 15 of a roll paper product comprising a plurality of solid support materials 12 affixed onto the single ply sheet 15. FIG. 2B is a cross-sectional view of the single ply sheet 15 of FIG. 2A taken along the line 2B-2B. The cross-sectional view shows a plurality of solid support materials 12 that are affixed onto the surface of the fibrous structure 16 of the single ply sheet 15. The solid support materials 12 are affixed onto both the top surface 17 of the fibrous structure 16 and the bottom surface 18 of the fibrous structure 16.

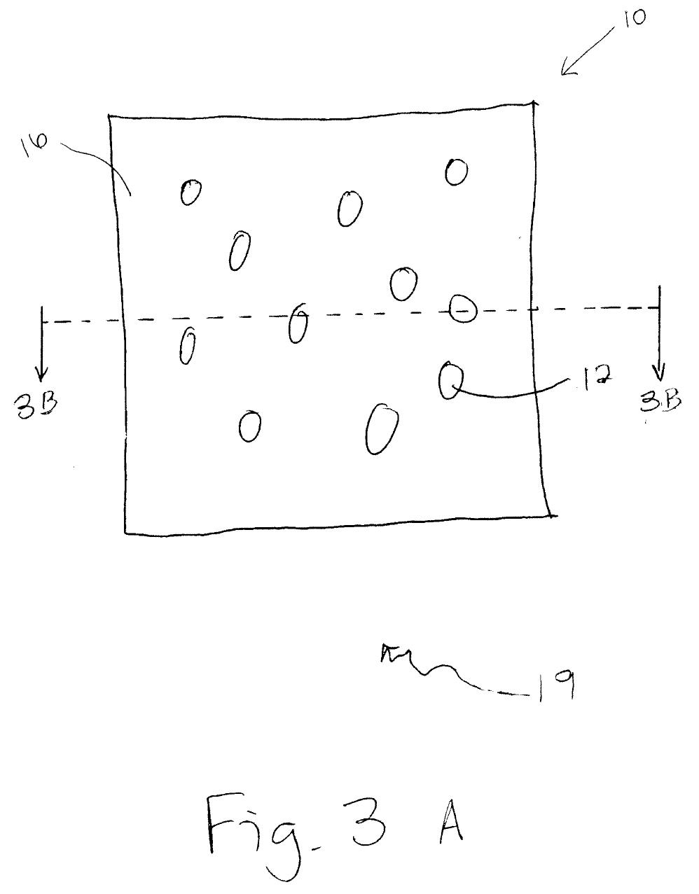

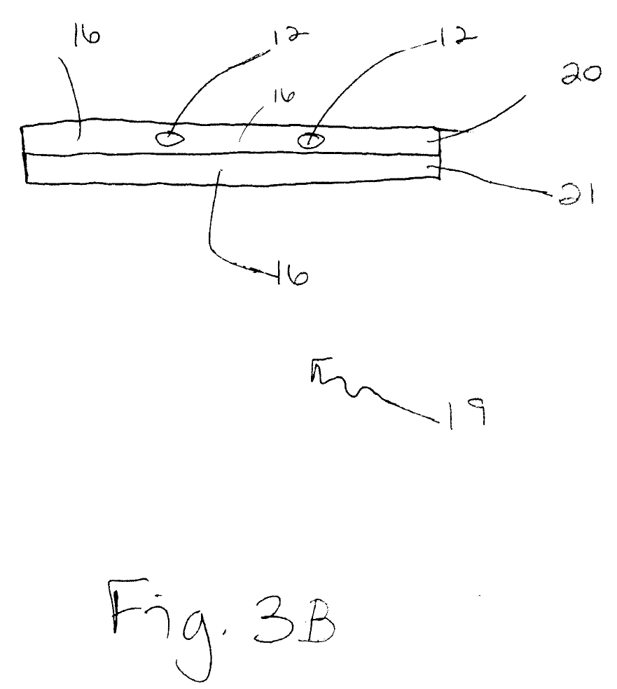

FIG. 3A shows an exemplary embodiment of a paper product 10 of the present invention wherein the paper product 10 comprises a multi-ply sheet 19 and a plurality of solid support materials 12 that are embedded in the fibrous structure 16. FIG. 3B shows an exemplary embodiment of a multi-ply sheet 19 of the paper product 10 of FIG. 3A. FIG. 3B is a cross-sectional view of an embodiment of the multiply sheet 19 of FIG. 3A taken along the line 3B-3B. In the embodiment shown in FIG. 3B, the multiply sheet 19 comprises a first ply 20 and a second ply 21 of fibrous structure 16. The first ply 20 comprises embedded solid support materials 12 which may be visible through the fibrous structure 16. In FIG. 3A the fibrous structure 16 completely surrounds each solid support material 12, and thus the product 10 comprises a plurality of discrete solid support materials 12.

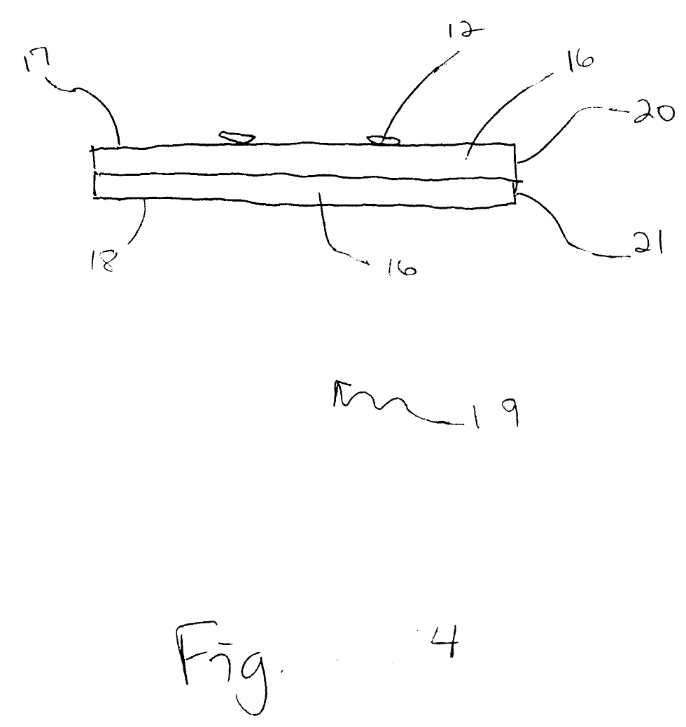

FIG. 4 is an alternative cross-sectional view of an embodiment of a multiply sheet 19. In the embodiment shown in FIG. 4, the multiply sheet 19 comprises a first ply 20 and a second ply 21 of fibrous structure 16. The first ply 20 has solid support materials 12 affixed to the top surface 17 of the first ply 20.

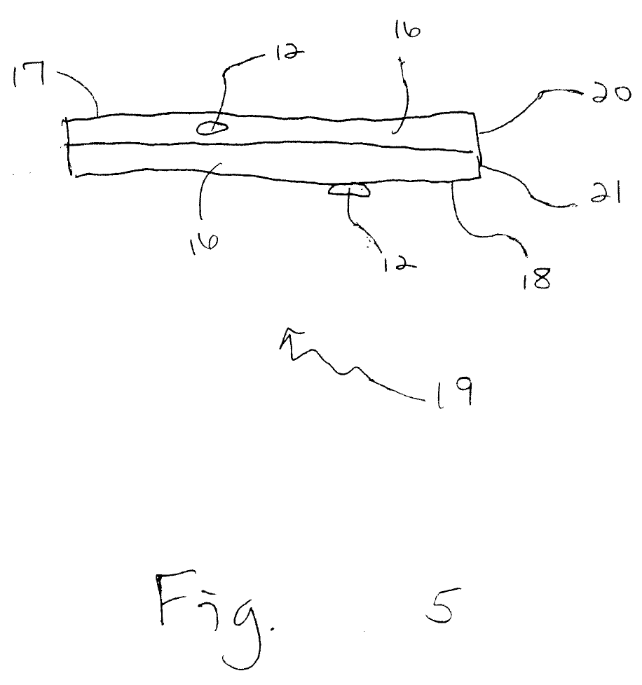

FIG. 5 is an alternative cross-sectional view of an embodiment of a multiply sheet 19. In the embodiment shown in FIG. 5, the multiply sheet 19 comprises a first ply 20 and a second ply 21 of fibrous structure 16. The second ply 21 has solid support material 12 affixed to the bottom surface 18 of the second ply 21 (e.g. the bottom surface may be the outside surface of the second ply 21). FIG. 5 also includes solid support material 12 embedded into the first ply 20.

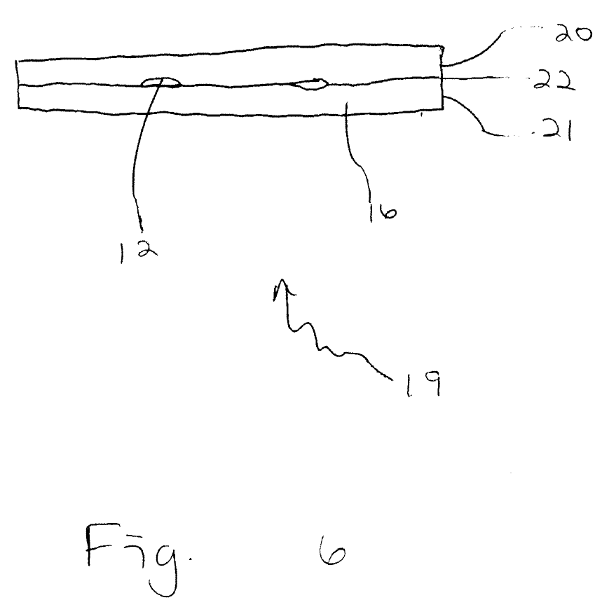

FIG. 6 is an alternative cross-sectional view of an embodiment of a multiply sheet 19. In the embodiment shown in FIG. 5, the multiply sheet 19 comprises a first ply 20 and a second ply 21 of fibrous structure 16. The first ply 20 and second ply 21 comprises solid support materials 12 which may be either embedded, or affixed to the plies 20, 21. The solid support materials are located in the interface 22 between the first ply 20 and the second ply 21.

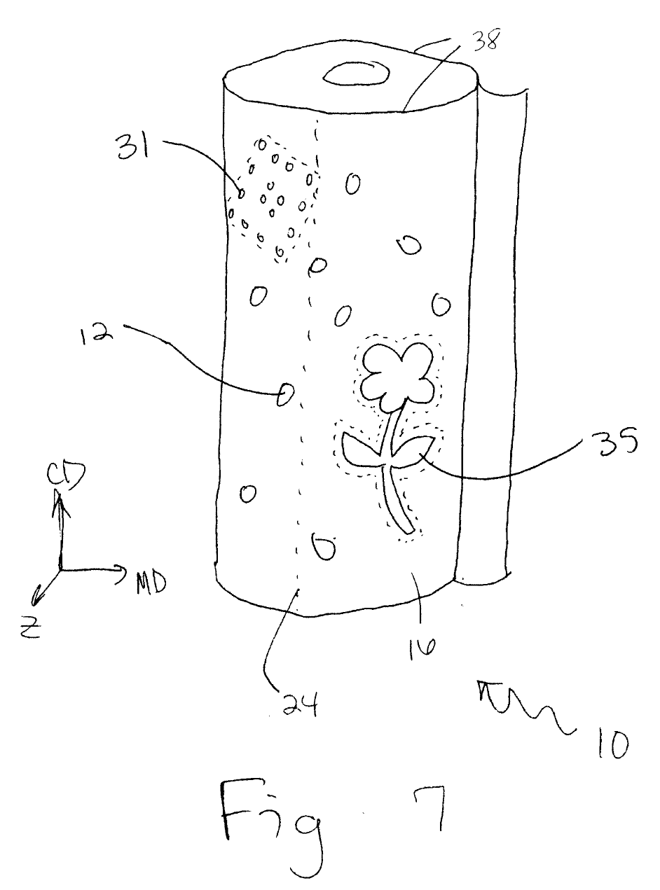

FIG. 7 is a perspective view of an exemplary embodiment of a roll paper product 10. The exemplary roll paper product 10 comprises a plurality of solid support materials 12. The roll paper product may further optionally comprise one or more embossments 31. In some embodiments, the roll paper product 10 may optionally comprise one or more printed elements 35. One of skill in the art will appreciate that the embossments 31 and/or printed elements 35 may be configured in any pattern or arrangement that is suitable for the intended purpose. In some embodiments the roll paper product 10 comprises only embossments 31 and solid support materials 12. In some other embodiments the roll paper product 10 comprises only printed elements 35 and solid support materials 12. In some other embodiments still, the roll paper product 10 comprises embossments 3 1, printed elements 35, and solid support materials 12.

The roll paper product 10 may have perforations 24 along the CD direction of the fibrous structure 16. One of skill in the art will appreciate that perforations may provide, among other things, the benefit of improved separability of sheets in the roll. In some embodiments the solid support materials 12 may be registered with the MD edge 38 of the sheet or with the perforations 24 in the CD direction. In some other embodiments, the solid support materials 12 may be registered with any embossments 31 and/or printed element 35.

One of skill in the art will appreciate that a product 10 may be made wherein the product 10 comprises solid support material 12 both embedded into, and affixed onto, the fibrous structure 16 of the product 10.

In one embodiment solid support materials 12 may be added to paper fibers during the papermaking process. For example, lavender flower buds are added to the fiber stock mix chest. The flower buds are added to provide a mixture of 2% flower buds, 70% softwood and 28% hardwood by weight. The mixture is then formed and dried using any suitable wet-laid papermaking process. An exemplary wet-laid processes is described in U.S. Pat. No. 3,301,746.

In another embodiment, cork pieces with cut lengths from about 10 mm to about 10 mm are blown onto the wet fiber mat prior to the wire suction boxes. The cork is added to the web at about 4% by weight. The wet fiber mat then passes over the wire suction boxes and is transferred, cork side down, to a forming fabric. Such a process may be exemplified by U.S. Pat. No. 4,191,609.

In another embodiment, a first ply of fibrous structure is sprayed with a laminating adhesive, such as, but not limited to, polyvinyl alcohol or other hot melt adhesive. Lavender flowers are blown onto the sheet at about 4% by weight. The first ply is married with a second ply so that the lavender flowers and adhesive are juxtaposed between the first and second plies or are located at the interface between plies of a multiply paper product.

In some embodiments, the solid support materials may be registered with lines of termination, e.g. perforations, on the sheets. An exemplary process of providing a product having such registered solid support materials may be as follows: (1) transporting a fibrous structure in a first direction at a first velocity; (2) spraying adhesive and blowing solid support material, such as lavender flowers, onto the structure at intervals at a second velocity to provide a first ply; (3) forming a second ply; (4) marrying the first ply to a second ply; (5) imparting a plurality of lines of termination to the resulting multiply fibrous structure from a blade movable at a third velocity, wherein the lines of termination form discrete sheets, and wherein the lines of termination are spaced apart from the solid support materials at a predetermined distance; and (5) varying one or more of the first, second or third velocities to adjust or maintain the predetermined distance.

The solid support materials and the lines of termination are disposed upon the fibrous structure relative to each other such that registration is created. In one embodiment the predetermined distance between the lines of termination and the solid support material has a tolerance range within about ±0.125 inches and in another example, a tolerance range within about ±0.063 inches. An exemplary method and/or apparatus for providing registration is described in U.S. Pat. No. 6,983,686.

Furthermore, in an embodiment the paper product comprises a Thickness Ratio of from about 1 to about 2, and/or from about 1 to about 1.5. In an embodiment the paper product comprising a plurality of solid support materials provides an improvement in the ability of the solid support materials to maintain thickness when wet, and thus the fibrous structure to maintain its thickness when the product is wet, especially in the regions of the solid support material. On the other hand fibrous structures in general tend to collapse when wetted.

In an embodiment, solid support material may be used with a fibrous structure to convey to a consumer that the fibrous structure and/or paper product comprising such fibrous structure exhibits a certain property or characteristic. In other words, the solid support material may function as a visual cue to inform a consumer that the fibrous structure has a certain property or characteristic such as thickness when wetted.

### Optional Embodiments

In some embodiments, a roll paper product may comprise embossments or printed elements. For example, a roll paper product may be embossed. Embossing is known in the paper arts and for use in all types of consumer paper products such as paper towels, toilet tissue, facial tissue, napkins, and the like. Those of skill in the art may appreciate that providing an embossment pattern provides, among other benefits, improved aesthetics regarding thickness and quilted appearance. Exemplary means and apparatus for embossing are described in U.S. Pat. Nos. 3,323,983, 5,468,323, 5,693,406, 5,972,466, 6,030,690 and 6,086,715.

Those of skill in the art may appreciate that embossing is performed in the dry end of the papermaking process and/or in a completely separate process, after the cellulosic fibrous structure web has already been formed.

In addition to embossed features, a roll paper product may have one or more surface patterns and/or features which are printed. In one embodiment, central impression printing may be used to provide ink to the fibrous structure products. Exemplary central impression printing methods and apparatus are described in U.S. Pat. Nos. 6,220,156, 6,283,024, and 5,083,511. In another embodiment, in-line printing may be used to provide ink to the paper products. Exemplary in-line printing methods and apparatus are described in U.S. Pat. App. No. 2006/0170729A1 and U.S. Pat. Nos. 6,587,133, 6,026,748, and 5,331,890. Alternatively, printing may be performed using any multi-stage printing apparatus for printing on absorbent paper products such as those exemplified in U.S. Pat. Nos. 5,638,752, 6,026,748, and 5,331,890.

### Test Methods

The following describes the test methods utilized herein to determine the values consistent with those presented herein. All measurements for the test methods are made at 23±1° C. and 50%±2% relative humidity, unless otherwise specified.

### Thickness Ratio Method

The Thickness Ratio represents the ratio of:

$$\frac{\begin{matrix}Z - direction thickness of wet \\ Sample of solid support material\end{matrix}}{\begin{matrix}Z - direction thickness of dry \\ Sample of solid support material\end{matrix}}$$

Samples are conditioned at 23±1° C. and 50%±2% relative humidity for two hours prior to testing. First, obtain a cross section sample of the solid support material for measurement of the z-direction thickness of the solid support material. Cut a sample (up to approximately 6 cm×6 cm) of dry fibrous structure, comprising one or more solid support materials, cutting through the center of a single solid support material. To stabilize the sample, clip the sample on the ends and avoid compressing the part of the sample that contains the cross-section of the solid support material. Orient the cross section of the solid support material in order to examine its cross section with a Nikon Eclipse E800 Light Microscope (Serial Number 260594/340207) set to 20× objectives. Measure the z-direction thickness in mm, of the cross section of the dry solid support material using a standard eye piece reticle calibrated using a N.I.S.T. Number 821/273087-06 scale. Then wet the same sample with a few drops of deionized water. Allow the sample to hydrate for about 15 seconds. Then measure the thickness in mm, of the same cross section of the wetted solid support material using a standard eye piece reticle also calibrated using a N.I.S.T. Number 821/273087-06 scale. Then take the value of the z-direction thickness of the wet Sample of the solid support material and divide this by the z-direction thickness of the dry Sample of the solid support material.

Repeat this procedure for 3 other samples (n=4) and obtain an average of this ratio for 4 samples. This value is the Thickness Ratio.

All publications, patent applications, and issued patents mentioned herein are hereby incorporated in their entirety by reference. Citation of any reference is not an admission regarding any determination as to its availability as prior art to the claimed invention.

“Comprising,” as used herein, means the term “comprising” and can include “consisting of” and “consisting essentially of.”

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. A paper product comprising:
one or more plies of fibrous structure;
a plurality of solid support materials embedded into or affixed to the fibrous structure;
wherein the solid support materials have a length of from about 0.5 mm to 60 mm, a width from about 0.5 mm to 60 mm, and a z-direction thickness from about 0.05 mm to about 5 mm.

2. The paper product of claim 1 wherein the solid support materials have a Thickness Ratio of from about 1 to about 2.

3. The paper product of claim 2 wherein the solid support materials have a Thickness Ratio of from about 1 to about 1.5.

4. The paper product of claim 1 wherein the solid support materials are embedded into the one or more plies.

5. The paper product of claim 1 wherein the solid support materials are affixed to the one or more plies.

6. The paper product of claim 1 wherein the solid support materials are further differentiated from the fibrous structure based on a property selected from the group consisting of: color, consistency, weight, basis weight, density, shape, light transmission, light absorption, refraction, luminosity, and combinations thereof.

7. The paper product of claim 1 wherein the solid support materials comprise from about 0.5% to about 50% by weight of the paper product.

8. The paper product of claim 7 wherein the solid support materials comprise from about 1% to about 25% by weight of the paper product.

9. The paper product of claim 1 wherein the solid support materials may be selected from the group consisting of: plant material, flower petals, leaves, fabric, sponge, cork, plastic, newspaper, soap, inorganic materials, shavings, and combinations thereof.

10. The paper product of claim 1 wherein paper product further comprises perforations and the solid support materials are registered with the perforations.

11. The paper product of claim 1 wherein the paper product further comprises embossments, printed features, and combinations thereof.

12. The paper product of claim 11 wherein the solid support materials are registered with the printed features or embossments.

13. The paper product of claim 1 having two or more plies, wherein the solid support materials are disposed between the two or more plies.

14. The paper product of claim 1 wherein the solid support materials are visually discernable.

15. The paper product of claim 1 wherein the product is selected from the group consisting of paper towels, facial tissues, napkins, and combinations thereof.

16. The paper product of claim 1 wherein the product comprises a random arrangement of the solid support materials.

17. The paper product of claim 1 wherein the product is in roll form.

18. A paper product comprising:
one or more plies of fibrous structure;
a plurality of solid support materials embedded into or affixed to the fibrous structure and comprising from about 0.5% to about 50% by weight of the paper product;
wherein the solid support materials have a length of from about 0.5 mm to 60 mm, a width from about 0.5 mm to 60 mm, and a z-direction thickness from about 0.05 mm to about 5 mm;
wherein the solid support materials have a Thickness Ratio of from about 1 to about 2.
